(19) United States
(12) Patent Application Publication
(10) Pub. No.: US 2012/0221578 A1
(43) Pub. Date: Aug. 30, 2012

(54) METHOD AND APPARATUS FOR CALCULATING EVALUATION SCORE ON CONTENTS BY USING USER FEEDBACK

(76) Inventor: Seo-Joon Kim, Seoul (KR)

(21) Appl. No.: 13/394,334

(22) PCT Filed: Dec. 30, 2009
(86) PCT No.: PCT/KR2009/007984

§ 371 Date: May 6, 2012

(30) Foreign Application Priority Data
Sep. 3, 2009 (KR) 10-2009-0083209

(51) Int. Cl. G06F 17/30

(52) U.S. Cl. 707/748; 707/E17.033; 707/E17.032

(57) ABSTRACT

The present invention relates to a method and apparatus for calculating an evaluation score of content by using user feedback. According to one aspect of the present invention, the method for calculating an evaluation score of content by using user feedback includes: calculating an evaluation score of each of a plurality of components constituting the content on the basis of the user feedback with respect to the plurality of components; and adding up evaluation scores of at least some of the plurality of components to calculate an evaluation score of the content.

### TECHNICAL FIELD

The present invention relates to a method and apparatus for calculating an evaluation score of contents by using user feedback.

### BACKGROUND ART

As people increasingly use a computer communication network (e.g., the Internet) in daily life, ordinary people, as well as experts, make great efforts to obtain information through the communication network. Also, a great number of computer users create various digital contents such as documents, photographs, videos, cartoons, maps, blogs, mini-home pages, sounds, music, skins, avatar and the like, and store the same in storage spaces of certain computers in the communication network, so the amounts of information that may be accessed through the communication network are growing exponentially. As a result, importance of a technique for effectively searching for information that is especially useful among the information accessible through the communication network is also increasing. The importance of such searching technique is the same even to the case of searching in a user's personal computer, as well as to the case of searching through the communication network.

In particular, a searching technique that allows users to search for information stored in computers connected to the communication network by using a search query term in relation to desired information, a directory or category to which contents containing the desired information belong, the date on which contents containing the desired information was created or posted, or the like is extensively utilized. Especially, information stored in a web server may be huge in amounts according to types of web servers, and is advantageous in that it can be easily accessed and used by users as they want in virtue of the characteristics of web servers. Thus, hereinafter, the description of the present invention will be largely focused on the technique for searching for information stored in web servers. However, it is obvious that such description of the present disclosure does not imply that the searching technique in accordance with the present invention cannot be used for searching for different types of information (e.g., information stored in a user's personal computer).

Conventional Internet searching techniques will be described in more detail. To begin with, a user accesses a server (e.g., a server of a search portal site) operating an Internet search engine through a web browser and inputs a search clause (typically, a search query term and/or category) in relation to desired information. Then, the search engine searches several web servers on the Internet to collect information regarding contents including information corresponding to the search clause input by the user, and provides a portion of the substance of the content and a URL indicating the position of the corresponding content and the like through the web browser of the user. The user may access the desired information by selecting the URL of the content or the like with reference to the provided substance of the content. The search engine may provide search results more quickly when the user performs searching through a web browser, by using a database having information periodically collected, classified, and indexed. Typical search portal sites which provide the search engine as described above are, for example, Google (www.google.com), Yahoo (www.yahoo.com), Naver (www.naver.com), Daum (www.daum.net), Altavista (www.altavista.com), and the like.

In this connection, a case in which the user performs a search query regarding a web document, which is one of examples of the most typical contents, may be considered. In this case, when the user inputs a certain search query term to a search window by using a web browser, with respect to the web document having information found with the search query term, the category of the web document, the name of the web site providing the web document, the title of the web document and the like, together with a simple preview of the substance of the web document, the URL, the size of the web document, the posting date of the web document and the like are provided.

### DISCLOSURE

### Technical Problem

Regarding evaluation of content that may be searched, more specifically, regarding evaluation of content by using user feedback, the inventor of the present application filed Korean Patent Application No. 2007-79999 (filed on Aug. 9, 2007, entitled “Method and apparatus for evaluating searched contents by using user feedback and providing search results by using evaluation results”), which was allowed as Korean Patent Registration No. 859918 (it should be appreciated that the description of the specification of the Patent is incorporated herein by reference in its entirety).

In addition to the preceding invention described above, the inventor of the present application devised an in-depth invention to variably evaluate contents by using user feedback and reached the present application.

### Technical Solution

It is, therefore, an object of the present invention to calculate an evaluation score of content itself on the basis of an evaluation score of an individual component of the content given by using user feedback.

Another object of the present invention is to identify an especially noticeable component of content and use the component in calculating an evaluation score of the content.

Still another object of the present invention is to perform necessary correction in calculating an evaluation score of content by using user feedback.

### BEST MODE

Representative configurations of the present invention to accomplish the above objects are as follows.

In accordance with one aspect of the present invention, there is provided a method for calculating an evaluation score of content by using user feedback, the method including: calculating an evaluation score of each of a plurality of components constituting the content on the basis of the user feedback with respect to the plurality of components; and adding up evaluation scores of at least some of the plurality of components to calculate an evaluation score of the content.

In accordance with another aspect of the present invention, there is provided a method for calculating evaluation scores of components of content by using user feedback, the method including: primarily calculating evaluation scores of components constituting the content on the basis of the user feedback with respect to the components; and correcting the primarily calculated evaluation scores with reference to at least one of positions, occupation areas, and visual effect indexes of the components within the content.

In accordance with still another aspect of the present invention, there is provided a method for calculating evaluation scores of components of content by using user feedback, the method including: primarily calculating evaluation scores of components constituting the content on the basis of the user feedback with respect to the components; and weighting the primarily calculated evaluation scores when the user feedback is repeated.

In accordance with still another aspect of the present invention, there is provided an apparatus for calculating an evaluation score of content by using user feedback, the apparatus including: an individual component evaluation score calculation unit for calculating an evaluation score of each of a plurality of components constituting the content on the basis of the user feedback with respect to the plurality of components; and a content evaluation score calculation unit for adding up evaluation scores of at least some of the plurality of components to calculate an evaluation score of the content.

In accordance with still another aspect of the present invention, there is provided an apparatus for calculating evaluation scores of components of content by using user feedback, the apparatus including: an individual component evaluation score calculation unit for primarily calculating evaluation scores of components constituting the content on the basis of the user feedback with respect to the components, and correcting the primarily calculated evaluation scores with reference to at least one of positions, occupation areas, and visual effect indexes of the components within the content.

In accordance with still another aspect of the present invention, there is provided an apparatus for calculating evaluation scores of components of content by using user feedback, the apparatus including: an individual component evaluation score calculation unit for primarily calculating evaluation scores of components constituting the content on the basis of the user feedback with respect to the components, and weighting the primarily calculated evaluation scores when the user feedback is repeated.

### Advantageous Effects

In accordance with the present invention, an evaluation score of content itself can be calculated on the basis of evaluation scores of individual components of the content.

In accordance with the present invention, an especially noticeable component of content can be identified and an evaluation score of the content can be calculated by using the component.

In accordance with the present invention, an evaluation score of content can be calculated more precisely by performing necessary correction.

### DESCRIPTION OF DRAWINGS

The above and other objects and features of the present invention will become apparent from the following description of embodiments, given in conjunction with the accompanying drawings, in which:

FIG. 1 is a view schematically showing the configuration of an overall system for calculating an evaluation score of content by using user feedback in accordance with an embodiment of the present invention.

FIG. 2 is a view showing a detailed configuration of a server 300 in accordance with an embodiment of the present invention.

FIG. 3 is a view showing an example of separating a single web document into six components.

### MODE FOR INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different from one another, are not necessarily mutually exclusive. For example, a particular feature, structure, and characteristic described herein in connection with one embodiment may be implemented within other embodiments without departing from the spirit and scope of the present invention. Also, it is to be understood that the positions or arrangements of individual elements in each of the disclosed embodiments may be changed without departing the spirit and scope of the present invention. The following detailed description is, therefore, not to be taken in a limiting sense, and the scope of the invention is defined only by the appended claims that should be appropriately interpreted along with the full range of equivalents to which the claims are entitled. In the drawings, like reference numerals identify identical or like functions throughout the several views.

Hereinafter, preferred embodiments of the present invention will be described in detail with reference to the accompanying drawings so that those skilled in the art to which the invention pertains can easily carry out the present invention.

### DESCRIPTIONS OF TERMS

In the present disclosure, “search” refers to a user's behavior of inputting a search clause such as a search query term, a directory or category, a content creation date or posting date, or the like on a communication network including the Internet or in a particular computer and obtaining the results therefrom to find useful information, or a supporting operation or function to allow for such a behavior. Such a search behavior, search operation, or search function may be freely performed or realized by using a server or other arithmetic operation devices to be described later. In accordance with the present disclosure, it should be understood that searched objects are not limited to files stored in web servers on the Internet.

### Embodiments of the Invention

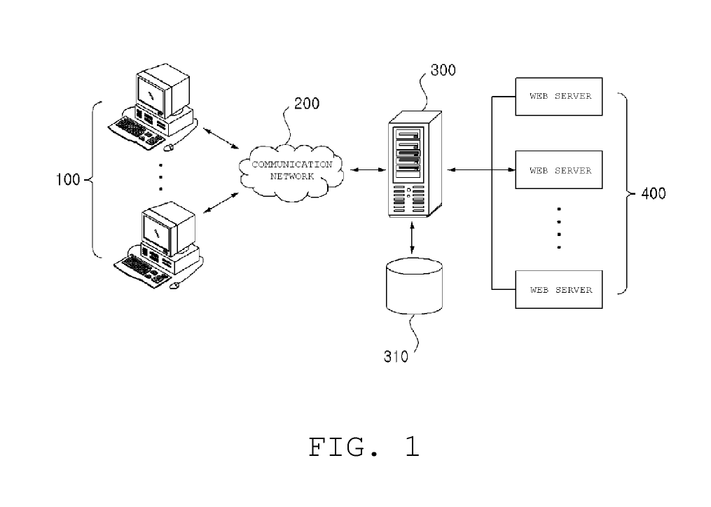

FIG. 1 is a view schematically showing a configuration of an overall system for calculating an evaluation score of content by using user feedback in accordance with an embodiment of the present invention.

As shown in FIG. 1, the overall system in accordance with the present invention may include a user computer 100, a communication network 200, a server 300 for calculating an evaluation score of content by using user feedback, a database 310 for storing content evaluated by using user feedback, and a plurality of web servers 400.

First, the communication network 200 may be configured without being limited to a communication mode such as a wired or wireless mode, and may be configured as various communication networks such as a local area network (LAN), a metropolitan area network (MAN), a wide area network (WAN), and the like. Preferably, the communication network 200 mentioned in the present invention may be a known world wide web (WWW).

In accordance with an embodiment of the present invention, the user computer 100 is a digital device used by a user to access the server 300 to search for information. A desktop computer, a notebook computer, a workstation, a personal digital assistant (PDA), a web pad, a mobile phone or the like may be variably adopted as the user computer 100 without limitation. The user may execute a web browser such as Internet Explorer™, Chrome™, Netscape™ or the like, or a known program for enabling information search using the user computer 100 to access the server 300 and then receive content from the server 300 and/or the web server 400. For such information search, the user may input a search clause to the program as necessary. Preferably, the user computer 100 may further include a user feedback information collecting module (not shown) and a local database (not shown) disclosed in Korean Patent Registration No. 859918. The user feedback information collecting module may interwork with an image sensor such as a web camera to obtain additional user feedback to be described later.

Meanwhile, in accordance with an embodiment of the present invention, the server 300 may store a search clause such as a search query term, category or the like transmitted from the user computer 100 in a search query buffer (not shown) to allow a search engine (not shown) included in the server 300 to search for and process information, and search results formed by the search engine may be stored in a search result buffer (not shown) and then provided such that the user can browse it.

In accordance with an embodiment of the present invention, the server 300 may calculate an evaluation score of content by using user feedback and store content given such an evaluation score in the database 310 according to the invention of Korean Patent Registration No. 859918 as described above and various embodiments described below.

In accordance with an embodiment of the present invention, the database 310 may store a plurality of contents which were given evaluation scores based on user feedback as mentioned above. Preferably, the evaluation score of each of the contents stored in the database 310 may be the sum of evaluation scores of all or some of components of each content.

Meanwhile, although FIG. 1 illustrates that the database 310 is configured to connect to the server 300, the database 310 may be configured to be included in the server 300 according to requirements of a skilled person in the art who implements the present invention. Meanwhile, the database 310 in accordance with the present invention encompasses a computer-readable recording medium, so it includes a database in a narrow sense, as well as a database in a broad sense including data logs based on a file system, or the like. Also, even a simple log set may be included in the database 310 in accordance with the present invention so long as it may be searched to extract data.

Finally, the plurality of web servers 400 in accordance with an embodiment of the present invention may provide content to the user computer 100 through the server 300. Corresponding content may be searched by the server 300 from the web servers 400 so long as the web servers 400 are connected to the communication network 200. Content searched by the server 300 may be stored in the database 310.

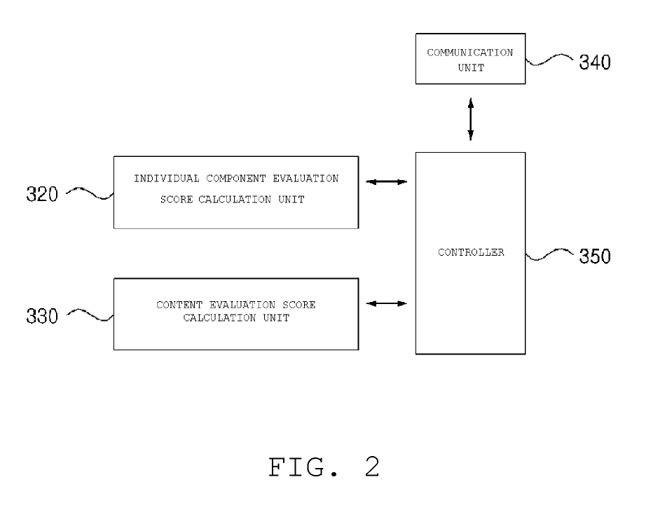

The configuration of the server 300 in accordance with an embodiment of the present invention will be described with reference to FIG. 2. FIG. 2 is a view showing a detailed configuration of the server 300 in accordance with an embodiment of the present invention.

As shown in FIG. 2, the server 300 in accordance with an embodiment of the present invention may include an individual component evaluation score calculation unit 320, a content evaluation score calculation unit 330, a communication unit 340, and a controller 350. In accordance with an embodiment of the present invention, at least some of the individual component evaluation score calculation unit 320, the content evaluation score calculation unit 330, the communication unit 340, and the controller 350 may be program modules which communicate with the user computer 100 and/or the web server 400. Such program modules may be included in the server 300 in the form of an operating system, an application program module, and other program modules, and may be physically stored in various known storage devices. Further, the program modules may also be stored in a remote storage device that may communicate with the server 300. Meanwhile, although the program modules may encompass a routine, a sub-routine, a program, an object, a component, a data structure or the like which performs a particular task or executes a particular abstract data type in accordance with the present invention as explained hereinafter, the present invention is not limited thereto.

First, the individual component evaluation score calculation unit 320 in accordance with an embodiment of the present invention may basically calculate evaluation scores of individual components of certain content on the basis of the technical idea of the invention of Korean Patent Registration No. 859918. Specifically, according to the invention of Korean Patent Registration No. 859918, user feedback may be collected with respect to at least one of a phrase, a sentence, a paragraph, a web link, an image, a video, and the like which are some of the components of the content. Such user feedback may be, for example, at least one of user's mouse clicks, mouse dragging, movement of a mouse pointer, keyboard input, use of a shortcut key, window resizing, window m, scrolling, copy, copy and paste, cut, cut and paste, save, and print manipulations. Also, the user feedback may be digitized, which may be at least one of time period during which a window displaying the content was activated and time period during which the window was displayed on the top of a user screen.

This will be described in more detail. First, the individual component evaluation score calculation unit 320 may calculate evaluation scores of at least some of a plurality of individual components included in one content, and store the calculated evaluation scores by matching them to the corresponding individual components. Here, an extension of a single content may be freely determined according to requirements of a skilled person in the art who implements the present invention, but hereinafter, content will be mainly illustrated as a web document having a single URL or URN, or something of the same property, for the sake of explanation.

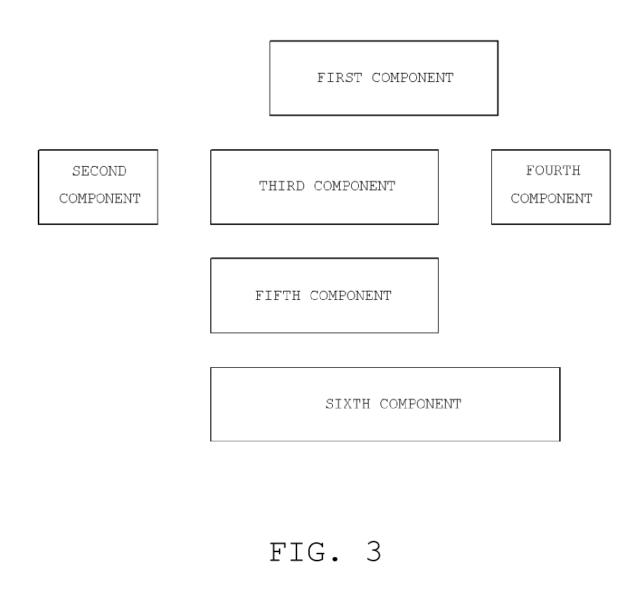

FIG. 3 is a view showing an example of separating a single web document into six components. For reference, such separation as shown in FIG. 3 may be made based on spacing between frames, texts, or images inherent in the web document, but such separation criteria may be variably changed without limitation according to requirements of a skilled person in the art who implements the present invention.

In accordance with the present embodiment, the individual component evaluation score calculation unit 320 may separate a single web document into six components as shown in FIG. 3. And then, the individual component evaluation score calculation unit 320 may calculate an evaluation score of each component by collecting user feedback made on the first to sixth components as described above. Each of the calculated evaluation scores may be matched to an identifier of each component (component ID) or each component itself and stored in the database 310.

More preferably, in calculating the evaluation scores of the individual components, the individual component evaluation score calculation unit 320 may correct the primarily calculated evaluation scores only based on user feedback with reference to the attributes of a corresponding component. Such correction may be to increase or decrease the primarily calculated evaluation scores.

In accordance with a preferred embodiment of the present invention, an attribute to be considered may be the positions of the individual components in the web document. In this connection, the results of the eye tracking researches conducted by Poynter Institute and released in December 2003 may be referred to with respect to the influence of the positions of components in a web page on a user's attention. Poynter Institute conducted researches on how long and to which positions of the web page components users pay attention in viewing a web page by using a pupil tracking device for a plurality of subjects. According to the research results, 68% of the entire subjects paid attention to components positioned on the left side of the screen, 55% paid attention to components positioned on the upper side of the screen, 34% paid attention to components positioned on the right side of the screen, and 14% paid attention to components positioned on the lower side of the screen. According to the research results, it can be inferred that the positions of the components in a single web page substantially affect generation of user feedback following a user's paying attention. Thus, the individual component evaluation score calculation unit 320 may multiply the primarily calculated evaluation scores by correction factors according to the positions of the components. For example, although a primary evaluation score of the first component in FIG. 3 is 100 and that of the sixth component in FIG. 3 is 80, evaluations scores obtained by multiplying the scores by the correction factors may be 50 (the first component) and 160 (the sixth component), exhibiting great changes (that is, the correction factor of the first component may be 0.5 and that of the sixth component may be 2). Such illustration indicates that the sixth component may be evaluated to have derived a user feedback value which does not greatly fall behind that of the first component, although it is generally taken for granted that the component positioned on the upper side in a single web document has a relatively higher possibility of generating user feedback while that positioned on the lower side has a relatively low possibility of generating user feedback. Likewise, the correction factor regarding the second component may be a value smaller than 1, while that of the fourth component may be a value greater than 1. Of course, the correction factors regarding the individual components in the web document may be freely determined without limitation according to requirements of a skilled person in the art.

Meanwhile, in accordance with a preferred embodiment of the present invention, an attribute to be considered may be the occupation areas of the individual components in a web document. According to the invention of Korea Patent Registration No. 859918 or according to the present invention, as the occupation area of an individual component in a web document is larger, the corresponding individual component has a higher probability of having a high primary evaluation score according to user feedback. Thus, a correction factor in consideration of the above may be involved in calculating evaluation scores of individual components.

Also, in accordance with a preferred embodiment of the present invention, an attribute to be considered may be the visual effect of the individual components in a web document. Such a visual effect is required to be considered particularly when an individual component is or includes an image or a video. That is, when a visual effect of an individual component is intense, a correction factor smaller than 1 may be multiplied thereto in calculating an evaluation score thereof. To this end, the intenseness of a visual effect may be digitized as chroma represented by a corresponding image or the like, or any other known visual effect indexes.

Meanwhile, in accordance with an embodiment of the present invention, the following may be significantly considered particularly in calculating evaluation scores among user feedback performed on certain individual components.

1. User's Positive Attention

In accordance with an embodiment of the present invention, in order to put emphasis on a user's positive attention, an eye position on a web document and a time period during which the gaze is maintained according to the result of eye detection may be included as user feedback. In order to obtain user feedback such as the eye position on the web document and the time period during which the gaze is maintained, various known techniques may be used, such as, for example, techniques disclosed in Korean Patent Laid-Open Publication No. 2007-43469 and Korean Patent Registration No. 749033 (it should be appreciated that descriptions of those documents are incorporated herein by reference in its entirety).

Meanwhile, in accordance with an embodiment of the present invention, besides that proposed in Korean Patent Registration No. 859918, the position itself of a pointer of a mouse manipulated by the user may be used as user feedback. More specifically, when the position of a mouse pointer is fixed for a certain amount of time or stays within a certain narrow region, an evaluation score of an individual component of corresponding content may be calculated to be high (this is based on the fact that the position of the mouse pointer largely has a high correlation with the user's eye position). In this case, as the time period during which the position of the mouse pointer is fixed or stays within a certain narrow region is lengthened, the evaluation score of the individual component of the corresponding content may be calculated to be higher.

However, only with such a logic, it may happen that, when the user is absent or the like, an evaluation score of an individual component is calculated to be erroneously high. Thus, the user's (positive) attention, as well as the position of the mouse pointer, may be considered to more appropriately calculate an evaluation score of an individual component. For example, when the user's (positive) attention is not accompanied, the position of the mouse pointer may be regarded as invalid user feedback. Such logic may be also applied to a time period during which a window displaying the content was activated, a time period during which the window was displayed on the top of the user screen, or the like.

Meanwhile, extending the foregoing embodiment, appropriateness of digitizing user feedback may be increased by additionally considering information regarding whether or not the user is positively paying attention or information regarding the user's gaze. In digitizing mouse clicks, mouse dragging, movement of the mouse pointer, window resizing, window movement, and the like which are substantially admitted to necessarily accompany the user's positive attention among the user feedback that can be taken into consideration, user's positive attention may be presupposed, or a numerical value of user feedback in case in which user's positive attention is not accompanied may be relatively lowered.

2. Relative Concentration of User's Positive Attention

When the user's eye position on a web document and a time period during which the user's gaze is maintained are determined and utilized as one of user feedback, it may be preferably discriminated which of the components on a single web document receive attention frequently or for a longer time, and a weight may be given to an evaluation score based on the corresponding user feedback. For example, assuming that a total of the time periods during which the user's eyes stay at any one of the first to sixth components in FIG. 3 is T, the individual component evaluation score calculation unit 320 may determine a time period during which the user's eyes stay at the i^{th} component as Tᵢ, and with respect to a component having a great Tᵢ/T value, multiply a certain weight to Tᵢ and utilize this as a factor for determining an evaluation score of the i^{th} component. Here, T may be substituted by a time period during which the user simply displays a corresponding web document on the screen.

3. User's Position

Extending the proposition of Section 1 or the like, a fact that the user is seated before the user computer 100 (preferably, in front of the screen) may be used as user feedback. Corresponding information may be collected by a known user position detection module. When it is detected that the user is seated in front of the user computer 100, such detection information may be used alone or together with the information obtained according to the proposition of Section 1 or the like. However, in digitizing user feedback or the like, the case in which the user is simply seated in front of the user computer 100 may be belittled in comparison to the case in which there is user's positive attention.

4. Repeated Generation of User Feedback

When the user discovers a component on a web document which is especially useful or interesting, the user tends to generate repeated user feedback such as frequent gazing or frequent mouse manipulation. Such a tendency is particularly salient when the corresponding component is exceptionally informative.

Thus, when user feedback is repeatedly generated with respect to a particular component within a certain amount of time, the individual component evaluation score calculation unit 320 may assign a weight to the evaluation score of the corresponding component based thereon.

Meanwhile, the content evaluation score calculation unit 330 in accordance with an embodiment of the present invention may basically add up the evaluation scores of several individual components of a single content which have been calculated by the individual component evaluation score calculation unit 320 to calculate an evaluation score of the corresponding content. Preferably, a certain threshold value may be applied to the evaluation scores of the individual components added up to calculate the content evaluation score. For example, when the evaluation scores given to the first and sixth components, among the first to sixth components of the web document as shown in FIG. 3, are less than a certain threshold value, the evaluation score of the web document may be determined as the sum of the evaluation scores of the second to fifth components.

In accordance with an embodiment of the present invention, the content evaluation score calculation unit 330 may separate several individual components included in the content into advertisement components and non-advertisement components and add up only the evaluation scores of one or more non-advertisement components to calculate an evaluation score of the content. Alternatively, the content evaluation score calculation unit 330 may measure a level of contribution of the content to advertisement by adding up only the evaluation scores of one or more advertisement components. Here, in order to discriminate the advertisement components and the non-advertisement components, the content evaluation score calculation unit 330 may refer to metadata, which is previously given to the individual components of the content, regarding whether they have advertisement characteristics, or may compare the texts or the like included in each individual component with the advertisement texts stored in a certain advertisement text database (not shown).

Meanwhile, the communication unit 340 in accordance with an embodiment of the present invention may serve to transmit and receive data to and from the server 300.

Meanwhile, the controller 350 in accordance with an embodiment of the present invention may serve to control data flow among the database 310, the individual component evaluation score calculation unit 320, the content evaluation score calculation unit 330, and the communication unit 340. That is, the controller 350 in accordance with the present invention may control the database 310, the individual component evaluation score calculation unit 320, the content evaluation score calculation unit 330, and the communication unit 340 to perform their unique functions by controlling data flow from the outside or between the respective elements of the server 300.

The embodiments in accordance with the present invention as described above can be implemented in the form of program instructions that can be executed by various computer components and recorded in a computer-readable recording medium. The computer-readable recording medium may include program instructions, data files, data structures, and the like alone or in combination. The program instructions recorded in the computer-readable recording medium may be specially designed and configured for the present invention or known and usable to a person skilled in the field of computer software. Examples of the computer-readable recording medium include a magnetic medium such as a hard disk, a floppy disk, or a magnetic tape, an optical recording medium such as a CD-ROM or DVD, a magneto-optical medium such as a floptical disk, and a hardware device specially configured to store and execute program instructions such as a ROM, a RAM, a flash memory, or the like. Examples of the program instructions include machine codes that are produced by a compiler as well as high level language codes that can be executed by a computer using an interpreter or the like. The hardware device may be configured to operate as one or more software modules in order to perform the processes in accordance with the present invention, and vice versa.

While embodiments of the invention has been shown and described, it will be understood by those skilled in the art that various changes and modifications may be made without departing from the spirit and the scope of the invention as defined in the following claims.

1. A method for calculating an evaluation score of content by using user feedback, the method comprising:
calculating an evaluation score of each of a plurality of components constituting the content on the basis of the user feedback with respect to the plurality of components; and
adding up evaluation scores of at least some of the plurality of components to calculate an evaluation score of the content.

2. The method of claim 1, wherein the calculating an evaluation score of each of a plurality of components comprises correcting primarily calculated evaluation scores based on the user feedback.

3. The method of claim 2, wherein the correcting primarily calculated evaluation scores comprises referring to positions of the corresponding components within the content.

4. The method of claim 2, wherein the correcting primarily calculated evaluation scores comprises referring to occupation areas of the corresponding components within the content.

5. The method of claim 2, wherein the correcting primarily calculated evaluation scores comprises referring to visual effect indexes of the corresponding components within the content.

6. The method of claim 1, wherein, in the calculating an evaluation score of each of a plurality of components, the user feedback includes the user's eye position and a time period during which the gaze is maintained.

7. The method of claim 1, wherein, in the calculating an evaluation score of each of a plurality of components, when the user feedback is repeated, an evaluation score corresponding to the user feedback is weighted.

8. The method of claim 1, wherein the calculating an evaluation score of the content comprises adding up only evaluation scores of non-advertisement components among the plurality of components.

9. The method of claim 1, wherein the calculating an evaluation score of the content comprises adding up only evaluation scores of advertisement components among the plurality of components.

10. A method for calculating evaluation scores of components of content by using user feedback, the method comprising:
primarily calculating evaluation scores of components constituting the content on the basis of the user feedback with respect to the components; and
correcting the primarily calculated evaluation scores with reference to at least one of positions, occupation areas, and visual effect indexes of the components within the content.

11. A method for calculating evaluation scores of components of content by using user feedback, the method comprising:
primarily calculating evaluation scores of components constituting the content on the basis of the user feedback with respect to the components; and
weighting the primarily calculated evaluation scores when the user feedback is repeated.

12-14. (canceled)

15. The method of claim 1, wherein, in the calculating an evaluation score of each of a plurality of components, the user feedback includes a position of a mouse pointer and a time period during which the position of the mouse pointer is fixed or stays within a certain area.

16. The method of claim 1, wherein, in the calculating an evaluation score of each of a plurality of components, the user feedback includes a fact that a user is seated before the user's computer.
